(19) United States
(12) Patent Application Publication
(10) Pub. No.: US 2021/0208551 A1
(43) Pub. Date: Jul. 8, 2021

(54) BUILDING MANAGEMENT SYSTEM AND POSITIONING METHOD IN BUILDING

(71) Applicant: Carrier Corporation, Palm Beach Gardens, FL (US)

(72) Inventors: Yuanjing Sun, Shanghai (CN); Zhenggang Zhu, Shanghai (CN); Zhen Jia, Shanghai (CN); Jinming Hao, Shanghai (CN); Peter R. Harris, West Hartford, CT (US); Benliang Li, Beijing (CN)

(21) Appl. No.: 17/058,810

(22) PCT Filed: Jun. 6, 2019
(86) PCT No.: PCT/US2019/035703

§ 371 Date: Nov. 25, 2020

(30) Foreign Application Priority Data
Jul. 4, 2018 (CN) 201810722941.4

(51) Int. Cl. G05B 15/02; G06F 30/13; G06F 16/909; G06K 19/06

(52) U.S. Cl. CPC G05B 15/02; G06F 30/13; G06F 16/909; G06F 2111/18; G06K 19/06028; G06K 19/06159; G06K 19/06037

(57) ABSTRACT

The present invention relates to a building management system based on identifiable marks that are arranged on terminal devices of a building and have a one-to-one correspondence with the terminal devices' own codes, the building management system comprising a user terminal, and the user terminal storing a database comprising codes of the terminal devices and comprising a scanning device for identifying and determining the identifiable marks, wherein an actual or relative location of the user terminal in the building can be determined by identifying and determining at least two identifiable marks. Moreover, the present invention further relates to an implementation method for the building management system based on identifiable marks. The building management system based on identifiable marks according to the present invention favors building management and the design, installation, debugging, management, and maintenance of terminal devices.

### TECHNICAL FIELD

The present invention relates to a building management system based on identifiable marks and an implementation method for a building management system based on identifiable marks.

### BACKGROUND ART

With the development of modern technologies and in an era of highly developed intelligent technologies, advanced devices have been more and more extensively used in modern office environments. Conventional methods have low installation and maintenance efficiency for electrical devices in a building system, such as fire alarm devices, air conditioning devices, and lighting devices. For example, operators may not necessarily know about devices and installation locations during construction in a building, which severely affect normal operations, maintenance and use of the building. Since the building cannot be managed in a unified and coordinated manner, labor and materials are wasted, and moreover, the increase of control items correspondingly increases the complexity of management and difficulty of maintenance and greatly increases operating costs of the property management.

Therefore, there is an urgent need for a building management system capable of solving the foregoing problems in an innovative way.

### SUMMARY OF THE INVENTION

In view of the foregoing, a building management system based on identifiable marks is provided according to a first aspect of the present invention, which effectively solves the above problems in the prior art and problems in other aspects. In the building management system based on identifiable marks according to the present invention, the identifiable marks are arranged on terminal devices of a building and have a one-to-one correspondence with the terminal devices' own codes. The building management system comprises a user terminal, and the user terminal stores a database comprising codes of the terminal devices and comprises a scanning device for identifying and determining the identifiable marks, wherein an actual or relative location of the user terminal in the building can be determined by identifying and determining at least two identifiable marks.

In an advantageous embodiment of an implementation method for the building management system based on identifiable marks according to the present invention, the codes of the terminal devices in the database are associated with CAD file data of the terminal devices.

In another advantageous embodiment of an implementation method for the building management system based on identifiable marks according to the present invention, the user terminal comprises a monitor configured to display a CAD design drawing of the terminal devices and/or physical locations thereof on the building's BIM drawings.

In yet another advantageous embodiment of an implementation method for the building management system based on identifiable marks according to the present invention, the user terminal displays, according to a user's need, one or more of product information, service life and maintenance information of the terminal devices.

In yet another advantageous embodiment of an implementation method for the building management system based on identifiable marks according to the present invention, the interactive system comprises a wearable monitor, and the wearable monitor interacts with the user terminal for displaying location information of the user transmitted from the user terminal.

In yet another advantageous embodiment of an implementation method for the building management system based on identifiable marks according to the present invention, the wearable monitor is a pair of Virtual Reality glasses.

In yet another advantageous embodiment of an implementation method for the building management system based on identifiable marks according to the present invention, the user terminal is a mobile smart device.

In yet another advantageous embodiment of an implementation method for the building management system based on identifiable marks according to the present invention, the mobile smart device is a mobile phone or a tablet computer.

In yet another advantageous embodiment of an implementation method for the building management system based on identifiable marks according to the present invention, the identifiable marks are machine-readable marks.

In yet another advantageous embodiment of an implementation method for the building management system based on identifiable marks according to the present invention, the machine-readable marks are 2-D codes, barcodes, or 3-D codes.

Moreover, a building management system based on identifiable marks is further provided according to a second aspect of the present invention. In the above building management system based on identifiable marks, the identifiable marks are arranged on terminal devices of a building and have a one-to-one correspondence with the terminal devices' own codes, the building management system comprising:

a server end that stores a database comprising codes of the terminal devices; and

a user terminal that is in communication connection with the server end and comprises a scanning device for identifying and determining the identifiable marks and sending the data to the server end;

wherein an actual or relative location of the user terminal in the building can be determined by identifying and determining at least two identifiable marks.

In an advantageous embodiment of an implementation method for the building management system based on identifiable marks according to the present invention, the codes of the terminal devices in the database are associated with CAD file data of the terminal devices.

In another advantageous embodiment of an implementation method for the building management system based on identifiable marks according to the present invention, the user terminal comprises a monitor configured to display a CAD design drawing of the terminal devices and/or physical locations thereof on the building's BIM drawings.

In yet another advantageous embodiment of an implementation method for the building management system based on identifiable marks according to the present invention, the user terminal displays, according to a user's need, one or more of product information, service life and maintenance information of the terminal devices.

In yet another advantageous embodiment of an implementation method for the building management system based on identifiable marks according to the present invention, a user of the user terminal and a user of the server end shares in an interactive manner the environment of the user terminal.

In yet another advantageous embodiment of an implementation method for the building management system based on identifiable marks according to the present invention, the interactive system comprises a wearable monitor, and the wearable monitor interacts with the user terminal for displaying location information of the user transmitted from the user terminal.

In yet another advantageous embodiment of an implementation method for the building management system based on identifiable marks according to the present invention, the wearable monitor is a pair of Virtual Reality glasses.

In yet another advantageous embodiment of an implementation method for the building management system based on identifiable marks according to the present invention, the user terminal is a mobile smart device.

In yet another advantageous embodiment of an implementation method for the building management system based on identifiable marks according to the present invention, the mobile smart device is a mobile phone or a tablet computer.

In yet another advantageous embodiment of an implementation method for the building management system based on identifiable marks according to the present invention, the identifiable marks are machine-readable marks.

In yet another advantageous embodiment of an implementation method for the building management system based on identifiable marks according to the present invention, the machine-readable marks are 2-D codes, barcodes, or 3-D codes.

Moreover, an implementation method for a building management system based on identifiable marks is further provided according to a third aspect of the present invention, wherein the identifiable marks are arranged on terminal devices of a building and have a one-to-one correspondence with the terminal devices' own codes, and the implementation method comprises the following steps:

identifying and determining at least two identifiable marks; and

determining an actual or relative location of a user terminal in the building.

In an advantageous embodiment of an implementation method for the building management system based on identifiable marks according to the present invention, the implementation method further comprises the following step:

displaying historical information of the user terminal.

In another advantageous embodiment of an implementation method for the building management system based on identifiable marks according to the present invention, the implementation method further comprises the following step:

interacting and sharing, by a user of the user terminal and a user of the server end, the location information.

It can be seen that the building management system based on identifiable marks and the implementation method thereof according to the present invention can assist field operating personnel in quickly extracting CAD information and the like of terminal devices in a user-friendly manner, and can share and interact with designers or managers at a cloud end with regard to different spaces, which favors the construction of daily operations of the entire building.

### BRIEF DESCRIPTION OF THE DRAWINGS

The technical solutions of the present invention will be further described in detail below with reference to the accompanying drawings and specific embodiments, wherein:

FIG. 1 is a schematic diagram of an identifiable mark and a code of a terminal device in an embodiment of the building management system based on identifiable marks according to the present invention;

FIG. 2 is a schematic diagram of an embodiment of the building management system based on identifiable marks according to the present invention at an installation stage;

FIG. 3 is a schematic diagram of an embodiment of the building management system based on identifiable marks according to the present invention at a debugging stage;

and

FIG. 4 is a schematic diagram of an embodiment of the building management system based on identifiable marks according to the present invention at a maintenance stage.

### DETAILED DESCRIPTION

The technical solutions in embodiments of the present invention will be clearly and completely described below with reference to the accompanying drawings in the embodiments of the present invention. Obviously, the described embodiments are merely some, not all, embodiments of the present invention. All other obtainable embodiments by a person skilled in the art without inventive effort shall fall within the scope of the present invention.

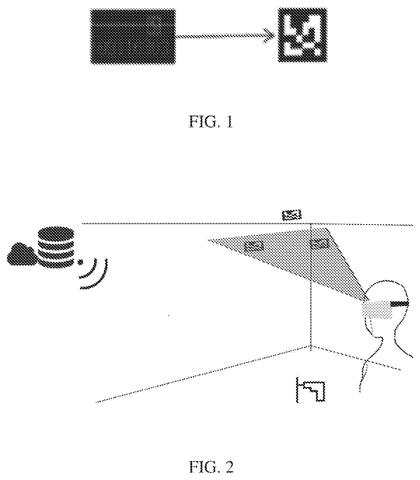

The present invention provides a specific implementation manner of a building management system based on identifiable marks. The identifiable marks (machine-readable marks such as 2-D codes, barcodes, or 3-D codes) can be fixed, by sticking or in other manners, on terminal devices of a building, such as fire alarm devices, and the identifiable marks must have a one-to-one correspondence with the terminal devices' own codes, as shown in FIG. 1. The building management system comprises a user terminal, such as a mobile phone or a tablet computer, and the user terminal stores a database comprising codes of the terminal devices and comprises a scanning device for identifying and determining the identifiable marks. When terminal devices of a building are maintained, a user or operator of the user terminal can determine an actual or relative location of the user terminal in the building by identifying and determining at least two identifiable marks. For example, the user scans two identifiable marks on a one-dimensional plane at a close distance, thereby obtaining the relative location of the space in which the user is located; for another example, the user identifies and determines three identifiable marks on different planes (see FIG. 2), and then determines the actual location of the user terminal in the building by means of precise positioning in the x direction, the y direction, and the z direction, such that the operator can be aware of his/her observation angle.

According to the preceding embodiment and in another preferred embodiment, the code of the terminal device in the database is associated with CAD file data of the terminal device. Specifically, after CAD drawings are analyzed, CAD file data of the terminal device is automatically encoded according to a preset rule to generate a unique code of the terminal device in the database of CAD design drawings. Further, the user terminal can also comprise a monitor configured to display a CAD design drawing of the terminal device and/or a physical location thereof on the building's BIM drawings (a person skilled in the art is aware that BIM is a file format for presenting 3D building models and the like). Further, the user terminal can display, according to the user's need, one or more of product information, service life and maintenance information of the terminal device. Specifically, the exclusive code of the terminal device is converted to an abstract machine-readable mark, and the operator of the user terminal can quickly learn, through a mobile smart device, such as a mobile phone or a tablet computer, what type of device this terminal device belongs to, the specific location of this terminal device, properties or attributes of this terminal device, and the like by scanning the machine-readable mark, which is very favorable for the maintenance of field devices.

Referring to FIG. 2 again, the interactive system can further comprise a wearable monitor, such as a pair of Virtual Reality glasses, wherein the wearable monitor can be designed to interact with the user terminal for displaying location information of the user transmitted from the user terminal.

Moreover, the present invention further provides another specific implementation manner of a building management system based on identifiable marks. The identifiable marks (machine-readable marks such as 2-D codes, barcodes, or 3-D codes) can be fixed, by sticking or in other manners, on terminal devices of a building, such as fire alarm devices, and the identifiable marks must have a one-to-one correspondence with the terminal devices' own codes. The building management system based on identifiable marks can enable installation or maintenance personnel of the terminal device to synchronously or asynchronously interact and share with a designer or manager not on the field via a wireless network or a wired network. Specifically, the building management system comprises a server end that stores a database comprising the code of the terminal device; and a user terminal, such as a mobile smart device like a mobile phone or a tablet computer, that is in communication connection with the server end and comprises a scanning device for identifying and determining the identifiable marks and sending the data to the server end. When maintaining a terminal device of a building, a user of the user terminal can determine an actual or relative location of the user terminal in the building by identifying and determining at least two identifiable marks. When encountering an issue during construction, such as a malfunction of the terminal device, the field operator must communicate with a manager or designer at the server end, and he or she can directly interact and share the problem observed on the field with the personnel at the server end, such that the manager or designer at the server end can perform remote debugging on the terminal device.

According to the preceding embodiment and in another preferred embodiment, the code of the terminal device in the database is associated with CAD file data of the terminal device. Further, the user terminal can also comprise a monitor configured to display a CAD design drawing of the terminal device and/or a physical location thereof on the building's BIM drawings. Further, the user terminal can display, according to the user's need, one or more of product information, service life and maintenance information of the terminal device. By converting the exclusive code of the terminal device to an abstract mark, such as a machine-readable mark like a 2-D code, a barcode, or a 3-D code, the operator can quickly learn, through a mobile smart device, what type of device this terminal device belongs to, the specific location of this terminal device, properties or attributes of this terminal device, and the like by scanning the machine-readable mark, so as to facilitate information interaction among multiple parties, such as a constructing party, a building party, and a maintaining party, thereby easily constructing daily operations of the entire building.

In the above embodiments, the interactive system can further comprise a wearable monitor for operators, wherein the wearable monitor can be designed to interact with the user terminal for displaying location information of the user transmitted from the server end.

Moreover, the present invention further provides an implementation method for a building management system based on identifiable marks, wherein the identifiable marks are arranged on terminal devices of a building and have a one-to-one correspondence with the terminal devices' own codes, and the implementation method comprises the following steps:

identifying and determining at least two identifiable marks; and

determining an actual or relative location of a user terminal in the building, thereby facilitating installing personnel to acquire a precise location of the terminal device as quickly as possible at an installation stage.

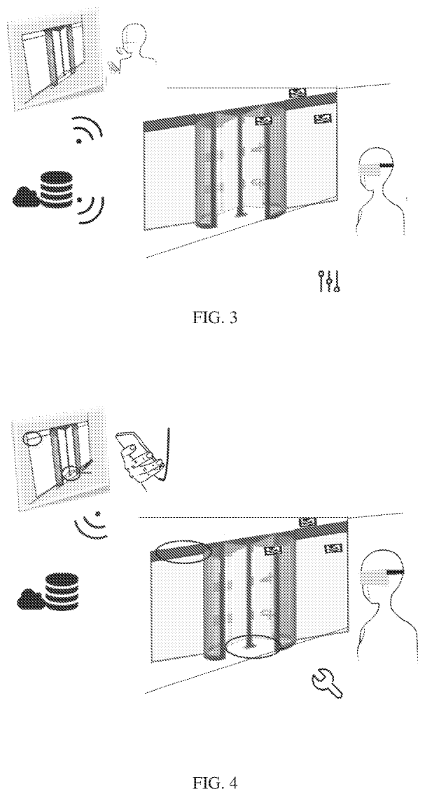

Furthermore, the implementation method further preferably comprises the following step:
displaying historical information of the user terminal, such that an operator at a debugging stage can obtain synchronous or asynchronous support, as shown in FIG. 3.

Furthermore, the implementation method further preferably comprises the following step:

interacting and sharing, by a user of the user terminal and a user of the server end, the location information. For example, maintaining personnel at a maintaining stage can interact or share, by scanning common read/write information, a CAD design drawing of the terminal device and/or relevant data thereof on the building's BIM drawings with personnel not on the site, as shown in FIG. 4.

In short, different participants at different stages of construction, such as architectures, designers, installation and construction personnel of HVAC or other building devices, and property managers or maintenance personnel after a building enters the use stage, can all use the implementation method for the building management system based on identifiable marks according to the present invention to share, synchronously or asynchronously, acquired information.

In summary, the building management system based on identifiable marks and the implementation method thereof according to the present invention can facilitate installation and maintenance personnel of a building to quickly grasp various information of terminal devices of the building, and to interact and share with designers at a cloud end if necessary, thereby performing effective management on daily operations of the building.

Several specific implementation manners are listed above to describe in detail the building management system based on identifiable marks and the implementation method for the building management system based on identifiable marks according to the present invention. These examples are provided only to describe the principle and implementation manners of the present invention, rather than limiting the present invention. Without departing from the spirit and scope of the present invention, a person skilled in the art can further make various modifications and improvements. Therefore, all equivalent technical solutions shall fall within the scope of the present invention and be defined by the claims of the present invention.

1. A building management system based on identifiable marks arranged on terminal devices of a building and having a one-to-one correspondence with codes of the terminal devices, wherein the building management system comprises a user terminal, and the user terminal is configured to store a database comprising the codes of the terminal devices and comprises a scanning device for identifying and determining the identifiable marks, and wherein at least one of an actual or relative location of the user terminal in the building can be determined by identifying and determining at least two identifiable marks.

2. The building management system according to claim 1, wherein the codes of the terminal devices in the database are associated with CAD file data of the terminal devices.

3. The building management system according to claim 2, wherein the user terminal comprises a monitor configured to display a CAD design drawing of at least one of the terminal devices and physical locations thereof on BIM drawings of the building.

4. The building management system according to claim 3, wherein the user terminal is configured to display, according to a user's need, one or more of product information, service life and maintenance information of the terminal devices.

5. The building management system according to claim 2, wherein the interactive system comprises a wearable monitor, and the wearable monitor interacts with the user terminal for displaying location information of the user transmitted from the user terminal.

6. The building management system according to claim 5, wherein the wearable monitor is a pair of Virtual Reality glasses.

7. The building management system according to claim 1, wherein the user terminal is a mobile smart device.

8. The building management system according to claim 7, wherein the mobile smart device is a mobile phone or a tablet computer.

9. The building management system according to claim 1, wherein the identifiable marks are machine-readable marks.

10. The building management system according to claim 9, wherein the machine-readable marks are 2-D codes, barcodes, or 3-D codes.

11. A building management system based on identifiable marks arranged on terminal devices of a building and having a one-to-one correspondence with codes of the terminal devices, wherein the building management system comprises:
a server end that stores a database comprising the codes of the terminal devices; and
a user terminal that is in communication connection with the server end and comprises a scanning device for identifying and determining the identifiable marks and sending associated data to the server end;
wherein at least one of an actual or relative location of the user terminal in the building can be determined by identifying and determining at least two identifiable marks.

12. The building management system according to claim 11, wherein the codes of the terminal devices in the database are associated with CAD file data of the terminal devices.

13. The building management system according to claim 12, wherein the user terminal comprises a monitor configured to display a CAD design drawing of at least one of the terminal devices and physical locations thereof on BIM drawings of the building.

14. (canceled)

15. The building management system according to claim 11, wherein a user of the user terminal and a user of the server end shares in an interactive manner the environment of the user terminal.

16. The building management system according to claim 11, wherein the interactive system comprises a wearable monitor, and the wearable monitor interacts with the user terminal for displaying location information of the user transmitted from the server end.

17. (canceled)

18. The building management system according to claim 11, wherein the user terminal is a mobile smart device.

19. (canceled)

20. The building management system according to claim 11, wherein the identifiable marks are machine-readable marks.

21. (canceled)

22. An implementation method for a building management system based on identifiable marks arranged on terminal devices of a building and having a one-to-one correspondence with codes of the terminal devices, wherein the implementation method comprises:
identifying and determining at least two identifiable marks; and
determining at least one of an actual or relative location of a user terminal in the building.

23. The implementation method for a building management system based on identifiable marks according to claim 22, wherein the implementation method further comprises:
displaying historical information of the user terminal.

24. The implementation method for a building management system based on identifiable marks according to claim 23, wherein the implementation method further comprises:
interacting and sharing, by a user of the user terminal and a user of the server end, the location information.
